(19) United States
(12) Patent Application Publication
(10) Pub. No.: US 2024/0151977 A1
(43) Pub. Date: May 9, 2024

(54) EYE-MOUNTED DISPLAY WITH ONBOARD EXECUTION OF REAL-TIME APPLICATIONS

(71) Applicant: Tectus Corporation, Saratoga, CA (US)

(72) Inventors: Michael West Wiemer, San Jose, CA (US); Renaldi Winoto, Los Gatos, CA (US); Anthony Tao Liang, Palo Alto, CA (US); Ronald Marianetti, Campbell, CA (US); Yu Song, Pleasanton, CA (US)

(21) Appl. No.: 18/498,085

(22) Filed: Oct. 31, 2023

Related U.S. Application Data
(60) Provisional application No. 63/422,395, filed on Nov. 3, 2022.

(51) Int. Cl. G02B 27/01; G02B 27/00; G02C 11/00

(52) U.S. Cl. CPC G02B 27/0172; G02B 27/0093; G02B 27/0179; G02C 11/10

(57) ABSTRACT

An independent eye-mounted device includes a display that projects pixels onto a retina of a user's eye. The device also includes a memory storing an application, and a processing device coupled to the memory to execute the application. The application populates a canvas with images of rendered graphic objects used by the application. The device further includes a real-time graphics module that, repeatedly and in real-time, transfers the images of the rendered graphic objects from the canvas to the display.

### CROSS-REFERENCE TO RELATED APPLICATION(S)

This application claims priority under 35 U.S.C. § 119(e) to U.S. Provisional Patent Application Ser. No. 63/422,395, “Dependent and Independent Electronic Contact Lens Display Systems,” filed Nov. 3, 2022. The subject matter of all of the foregoing is incorporated herein by reference in its entirety.

### BACKGROUND

### 1. Technical Field

This disclosure relates generally to eye-mounted displays, including electronic contact lenses.

### 2. Description of Related Art

Electronic contact lenses are one form of eye-mounted device. They are an emerging wearable sensing and display platform that promises information without distraction. Electronic contact lenses can provide enhanced visual experiences for athletes, travelers, technicians and military operators. Such lenses can also help low vision patients understand the world more easily.

Some designs for electronic contact lenses require the lens to send and receive data to external devices and the internet in order to operate properly. However, this may be undesirable for certain applications.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1A shows a user wearing an independent electronic contact lens.

FIG. 1B shows a magnified view of the electronic contact lens mounted on the user's eye.

FIG. 1C shows a cross sectional view of the electronic contact lens mounted on the user's eye.

FIG. 2 is a posterior view of an electronics assembly for use in an independent electronic contact lens.

FIG. 3 shows simplified graphics suitable for use in an independent electronic contact lens.

FIG. 4 shows updating simplified graphics in response to a change in eye angle.

FIG. 5 shows graphic objects for a virtual compass application.

FIG. 6 is a diagram of a graphics pipeline for the virtual compass application.

FIGS. 7A and 7B are flow diagrams of a loading stage and a display stage, respectively, for an application executing on an independent electronic contact lens.

FIGS. 8A and 8B are diagrams of hardware components and a software stack, respectively, for an independent electronic contact lens.

FIGS. 9-11 show additional examples of independent electronic contact lens systems.

FIG. 12 shows a pair of electronic contact lenses in an independent system.

FIG. 13 shows an independent electronic contact lens system with a body-worn repeater.

### DETAILED DESCRIPTION OF THE PREFERRED EMBODIMENTS

Electronic contact lenses are contact lenses that contain electronics. One class of electronic contact lenses includes a small projector that can project images onto the user's retina when the contact lens is worn. These electronic contact lenses may be designed to work as dependent or as independent systems. In a dependent system, the contact lens uses high-bandwidth communications with an external device which performs most of the computation necessary to generate the images to be projected. Significant components are located outside the lens, and the lens is dependent on connection to these components.

In an independent system, most or all of these computations are performed by components in the lens itself. These components may perform eye tracking, render images, update the display, and run real-time applications. These tasks may be simplified in order to reduce the size of the components and the power required to run the components. Data links to outside devices are limited or not used at all. For example, it may be limited to fetching data at relatively low rates, or for tasks which are not real-time.

Independent systems may be appropriate for users far from infrastructure other than possibly a cell phone or smart watch. For example, a jogger may want a hands-free display of heart rate based on data collected by his or her watch. In this case, a two-dimensional display is satisfactory and the communications bandwidth requirements are minimal.

In one approach, an independent contact lens uses a canvas and simplified graphics that are handled by a real-time graphics module. An application executing on the device populates the canvas with images (pixels) of rendered graphic objects used by the application. The real-time graphics module transfers the images of the graphic objects from the canvas to the display in real-time.

For example, in addition to the rendered images stored in the canvas, there may also be an accompanying listing of the graphic objects in the canvas, and sizes and locations of the graphic objects. The real-time graphics module may receive an eye angle (orientation) of the user's eye. It can then determine, based on the eye angle and the sizes and locations of the graphic objects, which graphic objects fall within the span of the display. It then transfers the pixels for those graphic objects from the canvas to the display.

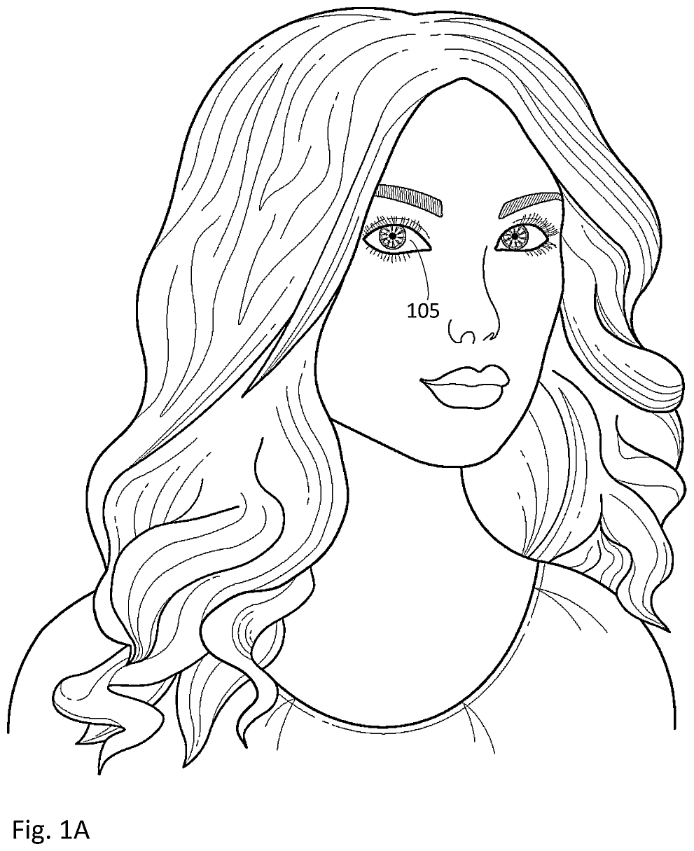

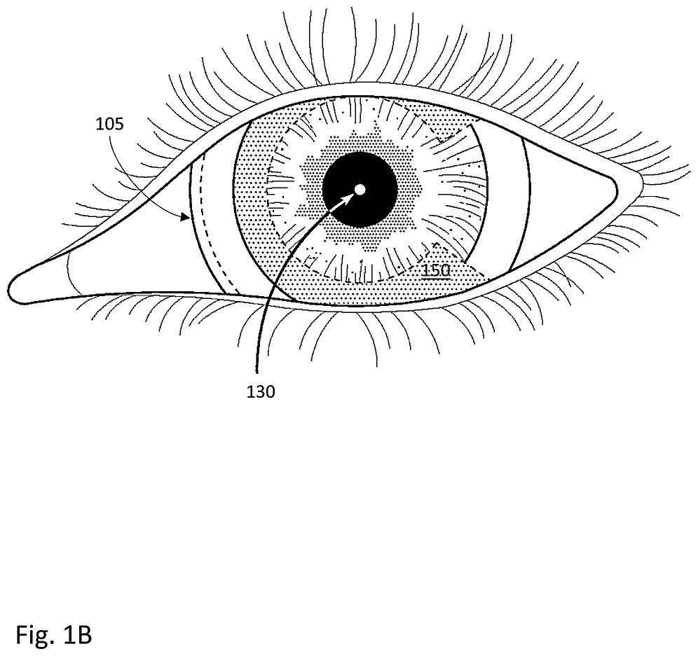

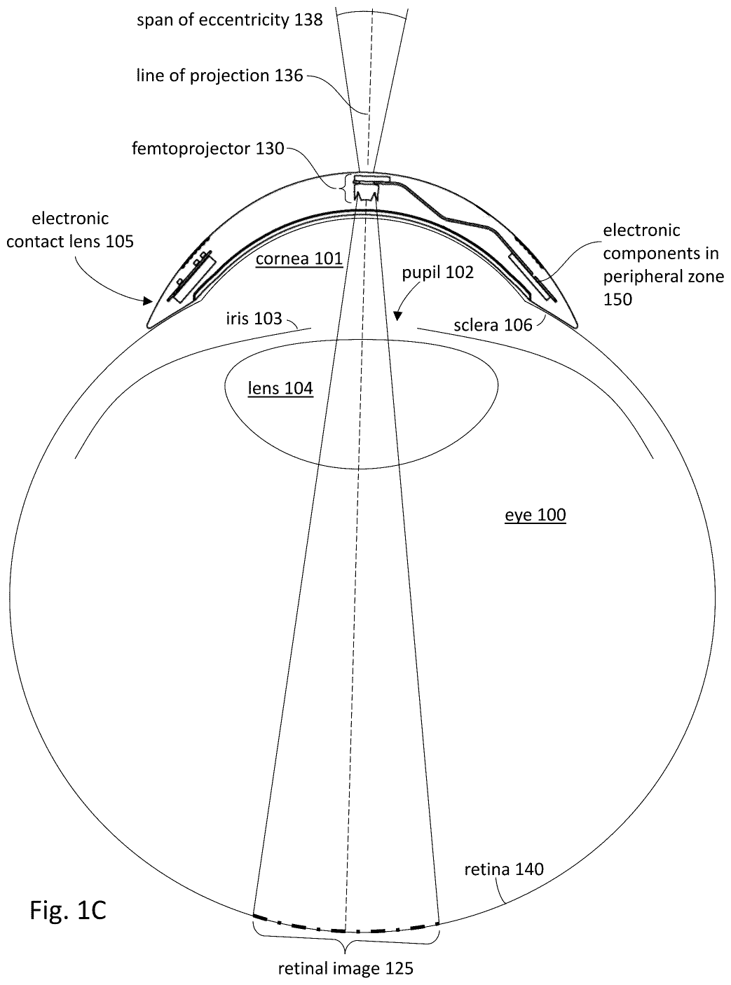

FIG. 1A shows a user wearing an independent electronic contact lens 105. FIG. 1B shows a magnified view of the electronic contact lens 105, and FIG. 1C shows a cross sectional view of the electronic contact lens 105. The electronic contact lens 105 is worn on the surface of the user's eye. The following examples use a scleral contact lens in which the contact lens is supported by the sclera of the user's eye, but the contact lens does not have to be scleral.

As shown in FIG. 1B, the electronic contact lens 105 contains a femtoprojector 130. The femtoprojector 130 is a small display that projects images onto the user's retina. The femtoprojector 130 is located in a central region of the contact lens, so that light from the femtoprojector 130 propagates through the user's pupil to the retina. The lead line from reference numeral 105 in FIG. 1B points to the edge of the contact lens. The femtoprojector 130 typically is not larger than 1 mm wide.

The electronic contact lens also includes other electronics, which may be located in a peripheral zone 150 of the contact lens. Electronic components in the lens may include microprocessors/controllers, motion sensors (such as accelerometers, gyroscopes and magnetometers), radio transceivers, power circuitry, antennas, batteries and elements for receiving electrical power inductively for battery charging (e.g., coils). For clarity, connections between the femtoprojector and electronics are not shown in FIG. 1B. Zone 150 may optionally be cut out, for example on the temporal (as opposed to nasal) side of the contact lens as shown in FIG. 1B. The electronic contact lens may include cosmetic elements, for example covering the electronics in zone 150. The cosmetic elements may be surfaces colored to resemble the iris and/or sclera of the user's eye.

FIG. 1C shows a cross sectional view of the electronic contact lens mounted on the user's eye. For completeness, FIG. 1C shows some of the structure of the eye 100, including the cornea 101, pupil 102, iris 103, lens 104, retina 140 and sclera 106. The electronic contact lens 105 preferably has a thickness that is less than two mm. The contact lens 105 maintains eye health by permitting oxygen to reach the cornea 101.

The femtoprojector 130 projects an image onto the user's retina. This is the retinal image 125 shown in FIG. 1C. This optical projection from femtoprojector 130 to retina 140 is also characterized by an optical axis, as indicated by the dashed line within the eye in FIG. 1C, and by some angular extent, as indicated by the solid lines within the eye in FIG. 1C. However, the femtoprojector may also be described by the equivalent quantities as measured in the external environment. The retinal image 125 will appear as a virtual image in the external environment. The virtual image has a center, which defines the line of projection 136 for the femtoprojector. The virtual image will also have some spatial extent, which defines the “span of eccentricity” 138 for the femtoprojector. The terms line of projection and span of eccentricity (SoE) for the femtoprojector refer to these quantities as measured in the external environment.

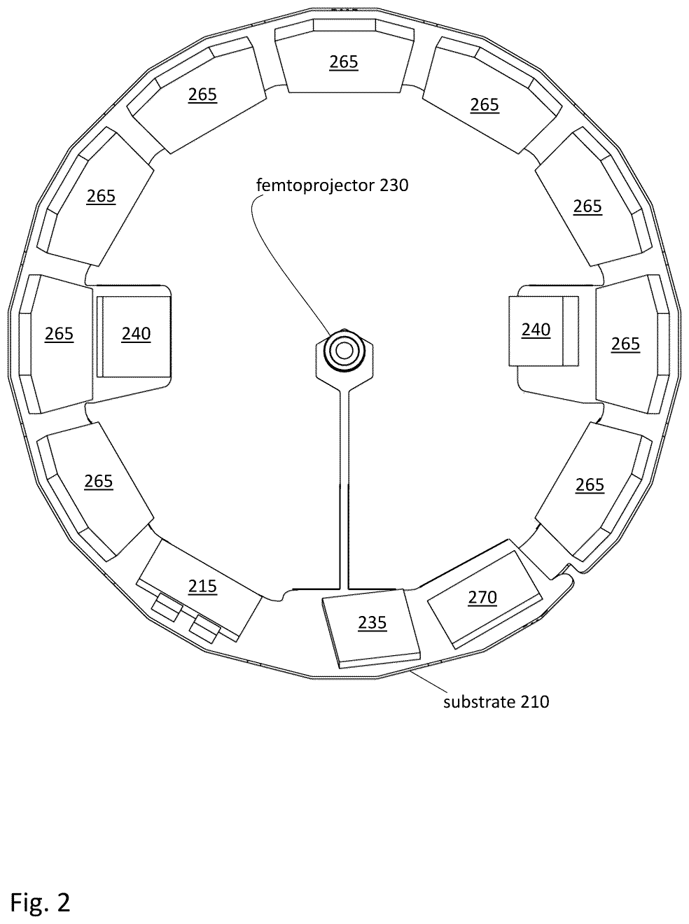

FIG. 2 is a posterior view of an electronics assembly for use in an independent electronic contact lens. The electronics assembly is approximately dome-shaped in order to fit into the contact lens. The posterior view of FIG. 2 shows a view from inside the dome. The perimeter of the dome is close to the viewer and the center of the dome is away from the viewer. The surfaces shown in FIG. 2 face towards the user's eye when the user is wearing the contact lens.

This particular design has a flexible printed circuit board 210 on which the different components are mounted. Conductive traces on the circuit board provide electrical connections between the different components. This flexible substrate 210 may be formed as a flat piece and then bent into the three-dimensional dome shape to fit into the contact lens. In the example of FIG. 2, the components include the femtoprojector 230. Other components include receiver/transmitter circuitry 215 (e.g., Bluetooth low energy radio), eye tracking routine and display pipeline (implemented on processor and memory 235), attitude and heading sensors and circuitry 240 (such as accelerometers, magnetometers and gyroscopes), batteries 265 and power circuitry 270. The electronic contact lens may also include antennae and coils for wireless communication and power transfer.

Power may be received wirelessly via a power coil. This is coupled to circuitry 270 that conditions and distributes the incoming power (e.g., converting from AC to DC if needed). The power subsystem may also include energy storage devices, such as batteries 265 or capacitors. Alternatively, the electronic contact lens may be powered by batteries 265, and the batteries recharged wirelessly through a coil.

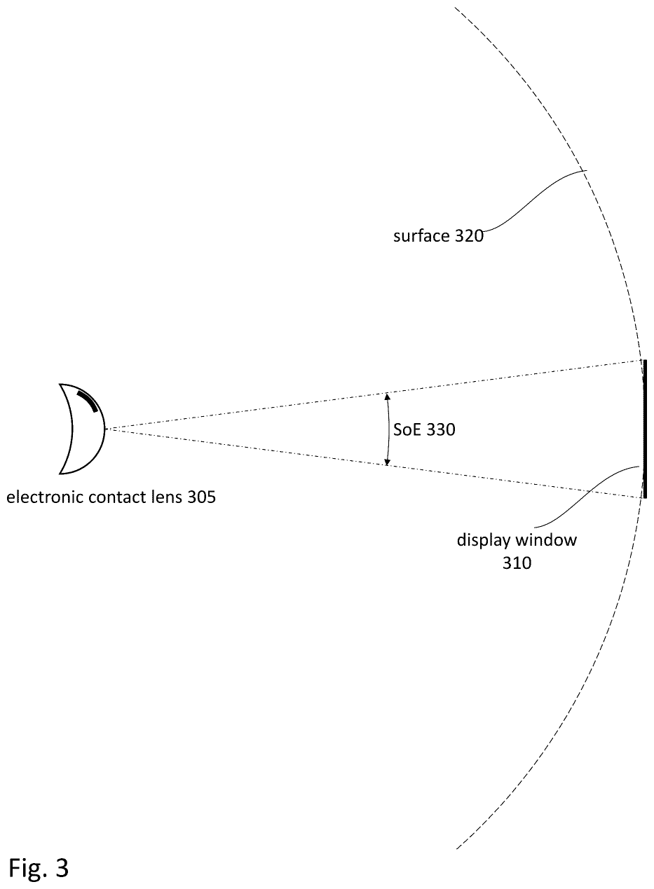

FIG. 3 shows an independent electronic contact lens 305 using simplified graphics due to the limited space and power available in the contact lens. In this case, the graphics are single-distance graphics that are rendered on a canvas and displayed at a constant distance as if on the inside of a sphere 320. The span of eccentricity 330 is typically in the range of 10-20 degrees and a patch of the inside surface 320 of a sphere falling within the typical SoE is adequately approximated by a flat surface. This patch may be referred to as the display window 310. As a user's eyes move, the (x, y) position of images is changed. Here, (x,y) may be spatial or angular coordinates. The images may also rotate. However, no other re-rendering is needed. The images are formed on a display in the contact lens and focused on the lens user's retina by a projection optical system. The combination of a microdisplay and projection optics within a contact lens is the femtoprojector.

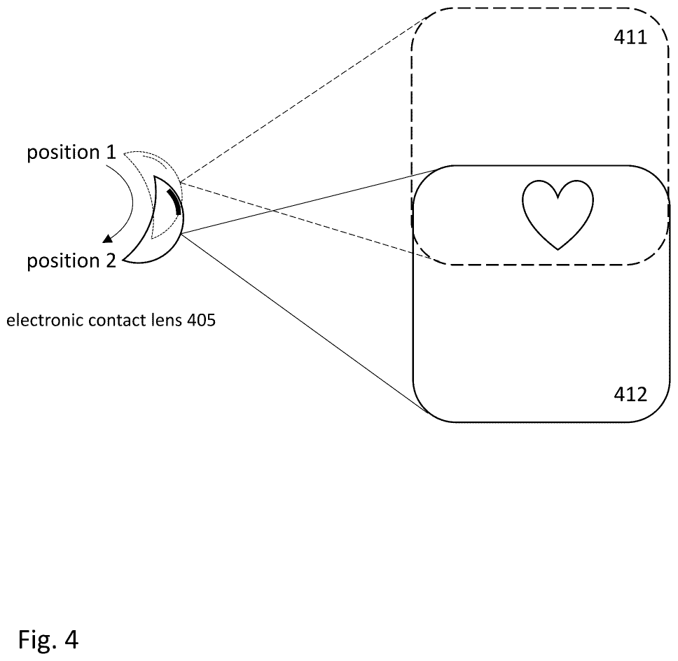

FIG. 4 shows updating the image projected by the femtoprojector in response to eye movement. Here, the single distance graphics is updated in response to lens reorientation by shifting an image in an (x, y) plane. In FIG. 4, an electronic contact lens 405 is illustrated in an initial position (1) and a final position (2). When the lens is in position 1, the user is looking upwards and the corresponding display window is shown by the dashed border 411. A heart-shaped graphic appears towards the bottom of the display window 411. When the lens is in position 2, the display window shifts downwards as shown by the solid border 412. In order for the heart shaped graphic to appear at the same location relative to the outside environment, it is moved towards the top of the display window 412. To accomplish this effect, the femtoprojector shifts the graphic image by |x|˜rθ where r is the apparent distance to the graphic object and θ is the angular distance from position 1 to position 2. In some independent systems, r is a constant so the shift is directly proportional to the angular change. No re-rendering of the graphic object into pixels is needed. Only the (x, y) position of the already rendered image changes as the user's eyes move. Here, a heart icon is translated across the two-dimensional display window as the lens rotates between positions.

According to Listing's Law, a person's eyes undergo torsion during verged up- or down-gazes. The magnitude of the torsion is approximately five degrees. To account for this effect, systems may rotate two-dimensional graphics (e.g. via a 2×2 rotation matrix) in addition to performing (x, y) translation.

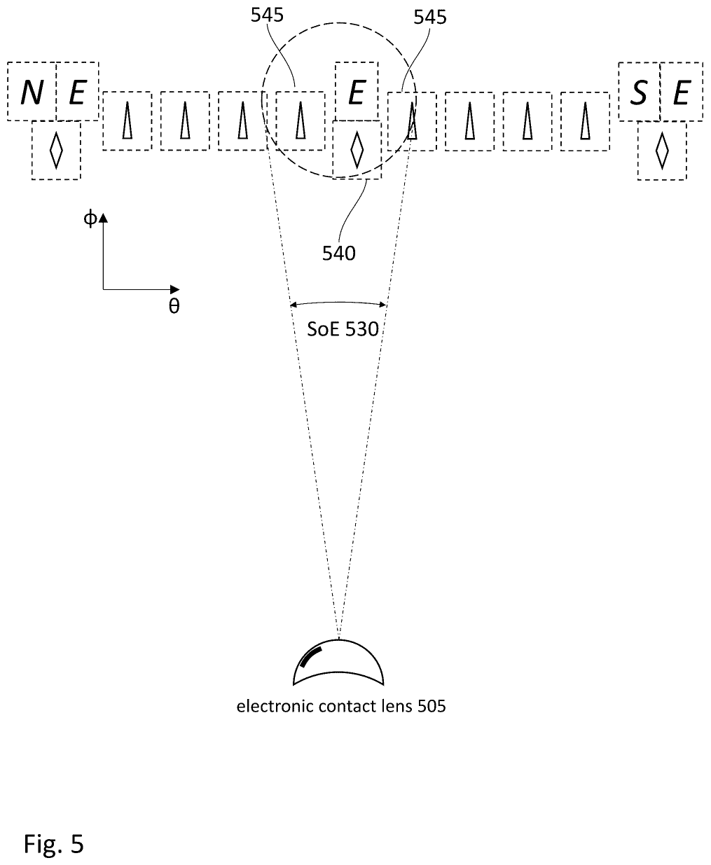

FIG. 5 show an example of a virtual compass application. This application displays a virtual compass overlaid on the outside world. FIG. 5 shows the graphic objects used by the virtual compass application. They include letters N, S, E, W representing the four primary compass directions. These letters may be combined to form the secondary directions NE, SE, NW, SW. The graphic objects also include a diamond-shaped major tick mark 540 that appears under each of the primary and secondary directions, and triangular minor tick marks 545 that appear between these directions. In the virtual compass application, these graphic objects appear superimposed on the outside world in the corresponding directions. In this example, the graphic objects are two-dimensional flat objects at a fixed distance and of a fixed size.

In FIG. 5, the user is looking east, so they see E above major tick mark 540, and minor tick marks 545 to either side. The SoE 530 is the extent of the image produced by the electronic contact lens 505. As the user looks to either side, they will see other parts of the virtual compass. The virtual compass may be modeled as a virtual environment that contains all of the graphic objects at certain locations within that environment. The locations of the graphic objects within the virtual environment may be defined by the eye angle (θ,ϕ), where θ is azimuth and ϕ is elevation. The SoE 530 is a window to that environment. The application loads rendered versions of the graphic objects into the canvas and identifies their locations within the environment. The real-time graphics module determines which of the graphic objects fall within the current display window and transfer the previously rendered images of those graphic objects from the canvas to the display.

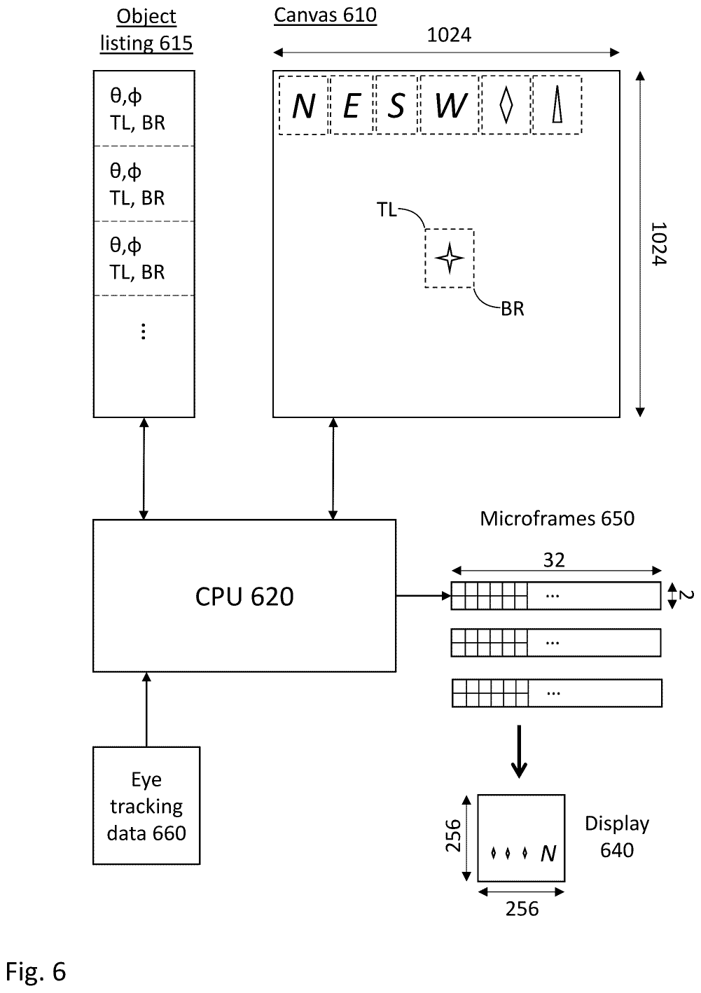

FIG. 6 is a diagram of a graphics pipeline for the virtual compass application. The end of the pipeline is the display 640, which projects images onto the user's retina. In this example, the display handles images that are 256×256. The pipeline also includes the canvas 610 and associated object listing 615. These two together define which graphic objects are located at which locations with the virtual environment produced by the application. The canvas 610 contains the graphic objects used by the application, but already rendered into pixels. In this example, the canvas 610 is 1024×1024. The object listing 615 is a listing of the graphic objects in the canvas 610, and their locations and sizes in the virtual environment. CPU 620 runs the application. In this example, the real-time graphics module is implemented in software and also run by CPU 620. However, it could also be implemented as hardware.

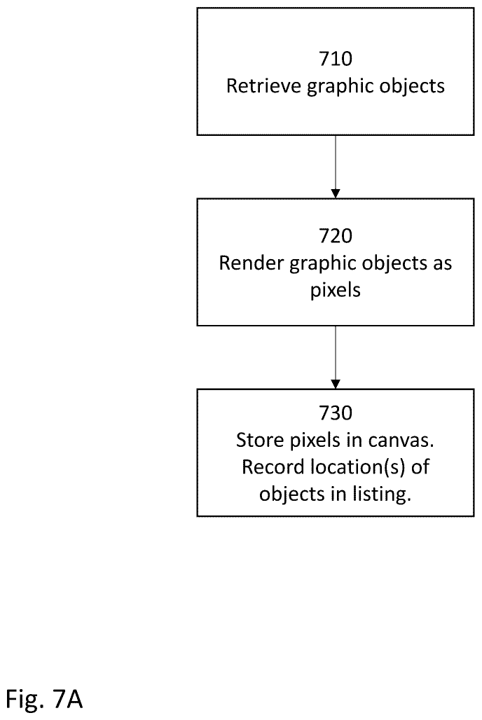

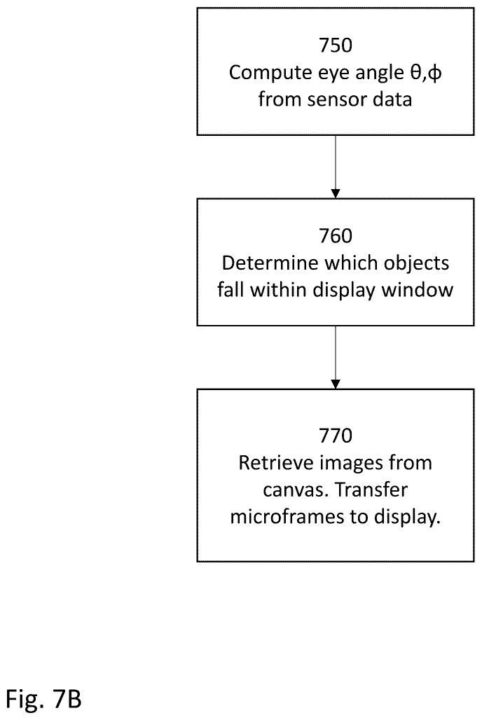

Operation of the system has two stages: a loading stage shown in FIG. 7A and a display stage shown in FIG. 7B. The loading stage populates the canvas, which includes the canvas 610 and object listing 615. The display stage transfers the images from the canvas 610 to the display 640, based on where the user is looking, i.e., based on the eye angle (04) of the user and based on the locations of the objects as provided in listing 615.

FIG. 7A is a flow diagram of the loading stage, which may be performed by execution of the application. The loading stage may be performed prior to the real-time execution of the display stage. At 710, the graphic objects used by the application are retrieved from memory. If not yet in pixel form, the graphic objects are rendered into pixels at 720. A graphics engine may do this. At 730, these images are stored in the canvas 610. The locations of these objects on the canvas are recorded in the associated object listing 615.

For example, one graphic object is the letter N. It may be stored as (N, calibri, 12 font). At 720, this is rendered into an image of pixels. At 730, this image is stored in the canvas 610 and its location(s) in the virtual environment are recorded in the listing 615. Here, the letter N is located in three places: once directly north, once to the northeast as part of the text “NE” and once to the northwest as part of “NW.” The canvas 610 stores one image of N, and the listing 615 lists three different locations for this image. In one approach, the locations are defined by the eye angle (θ,ϕ) to the center of the object and the size of the rendered object. If the images are rectangular, the size may be defined by specifying the top left (TL) and bottom right (BR) corners as indicated in FIG. 6.

The compass application could be implemented by specifying “NE” as a single graphic object rather than composed of the two objects N and E. In that case, the object N would have only one location in listing 615. The canvas 610 would contain an additional image for NE, with a corresponding location in listing 615.

The tick marks 540 and 545 could be defined by coordinates for their vertices. In that case, they are rendered into pixels at 720. These images are stored in the canvas 610, with corresponding locations in listing 615 at 730. There will be 8 locations for the major tick mark 540 and 32 locations for the minor tick mark 545.

Some graphic objects may be pre-rendered. Rather than receiving a graphic object defined as (N, calibri, 12 font), the graphic object may be an array of pixels which are an image of an N. Rather than receiving coordinates defining tick marks, the graphic object may be an array of pixels which are images of tick marks. In the loading stage, step 720 may be skipped and the canvas is populated by transferring images of pre-rendered graphic objects to the canvas and listing.

All graphic objects in the entire virtual environment need not be loaded. For example, graphic objects which are far away from the current display window may be loaded only when the eye angle comes closer to their locations. As another variation, different versions of graphic objects may be loaded. For example, if the graphic object is three-dimensional or dynamic in some fashion, different versions may be loaded and the correct version used depending on the eye angle or other conditions.

Once the canvas is loaded, the display stage produces images in real-time. FIG. 7B is a flow diagram of the display stage, which may be performed by the real-time graphics module. In FIG. 6, the real-time module receives eye tracking data 660. The independent contact lens may contain accelerometer(s), a gyroscope and a magnetometer. These can provide sensor measurements from which the real-time module computes the eye angle at 750. From the eye angle and the known locations of the different graphic objects on the canvas, the real-time module can determine which objects fall within the current display window at 760. At 770, the images for these graphic objects are retrieved from the canvas 615 and transferred to the display 640.

As the eye angle changes, this process is repeated to refresh the display. In some applications, the display is refreshed at a frame rate of 100 frames per second or more. In one approach, every frame is rebuilt by transferring all of the relevant images from the canvas to the display. In the example of FIG. 4, the entire heart is retransferred from the canvas to the display 100 times per second as the eye is looking from position 1 to position 2.

This refresh may be accomplished by using microframes 650, as shown in FIG. 6. Microframes are small portions of the frame buffer. They are 32×2 in the example of FIG. 6, whereas the frame size is 256×256. The display 640 may not be persistent, requiring the retransfer of microframes periodically to refresh the presence of objects in the display window. The microframes may be generated by which graphic objects are located within the display window. Those objects may generate microframes which transfer the corresponding images from the canvas 610 to the display 640. With this approach, only those pixels in the display that contain graphic objects need be refreshed, rather than refreshing all 256×256 pixels. This can reduce the amount of data transfer.

In a different approach, if images are already in a display buffer used to drive the display, they may be shifted to new locations within the buffer to account for eye movement. If there is no eye movement, the display buffer may remain the same, rather than refreshing the entire buffer with the same information.

The loading stage of FIG. 7A may be performed concurrently with the display stage of FIG. 7B. For example, if the canvas does not contain all graphic objects, it may be updated as the user's eye angle changes. In one approach, both the display stage and the loading stage run during execution of the application, but the display stage has a higher refresh rate and takes priority over the loading stage.

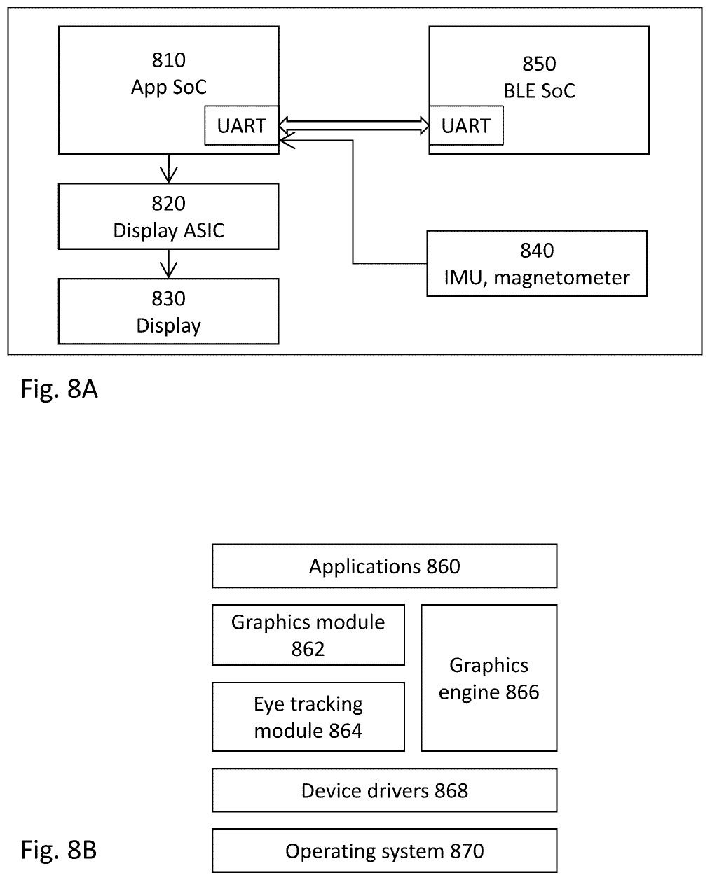

FIGS. 8A and 8B are a hardware block diagram and software stack for an independent electronic contact lens. In FIG. 8A, the hardware components include an App SoC 810, display ASIC 820 and display 830. The App SoC includes processor(s) such as a CPU and GPU. It also includes memory. The App SoC 810 includes CPU 620 of FIG. 6. The canvas 610 and object listing 615 may also be implemented in the memory of SoC 810. The applications are run on SoC 810. Sensors 840, such as an inertial measurement unit (IMU) and magnetometer provide measurements to the SoC 810, for calculation of the eye angle.

The display 640 in FIG. 6 may include some or all of the display ASIC 820 in addition to the display 830. This ASIC 820 drives the display 830, which may include an LED array. For example, the ASIC 820 may generate and control the transfer of microframes to the display.

The hardware in FIG. 8A also includes a wireless link 850, such as a low energy Bluetooth (BLE) radio operating at 2.45 GHz. This can be used to communicate to outside the contact lens, but the real-time graphics module may not use this link. In the virtual compass example, the display pipeline is contained within the contact lens itself. The wireless link 850 may be used for other purposes, such as loading applications onto the contact lens or pre-rendering graphics as part of the loading stage.

FIG. 8B shows a software stack. The top of the stack are the applications 860, such as the virtual compass application. The bottom of the stack is a real-time operating system 870. The other components include the following. The real-time graphics module 862 updates the display as described above. The eye tracking module 864 receives measurements from the sensor 840 and determines the eye angle. The graphics engine 866 renders objects to pixels as needed. The stack also includes various device drivers 868.

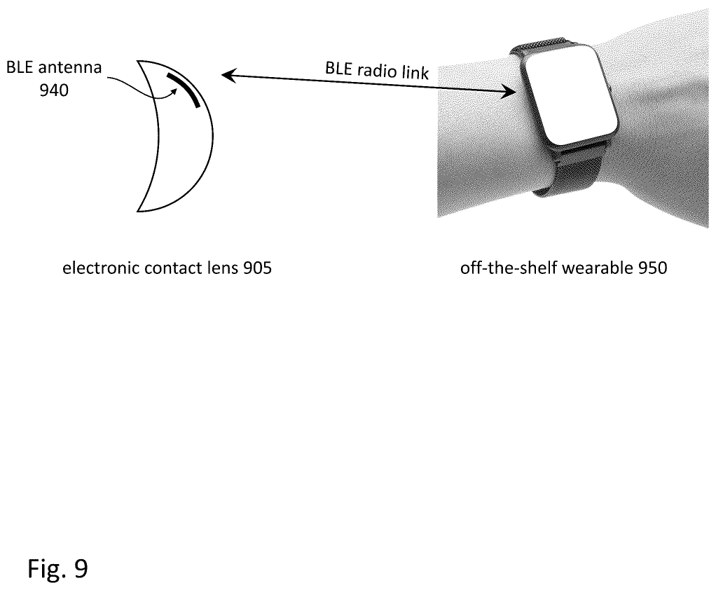

FIGS. 9-11 show additional examples of independent electronic contact lens systems. In FIG. 9, an electronic contact lens 905 is equipped with and contains: an ultrahigh frequency (UHF) off-the-shelf radio transceiver, such as a Bluetooth Low Energy (BLE) transceiver; a UHF radio antenna 940; motion sensors (such as accelerometers, gyroscopes and magnetometers); a display with projection optics for projecting images onto a wearer's retina; a nano CPU, nano GPU and nano memory. A nano CPU or GPU is one that can run within the extreme size and power constraints associated with a contact lens. The lens communicates with an off-the-shelf, wearable device 950 which includes a UHF transceiver and antenna, an optional connection to the internet, and wearable-class CPU, GPU and memory. Examples of such off-the-shelf devices include smart watches, heart rate monitors, continuous glucose monitors, altimeters, GNSS receivers, temperature sensors, radiation sensors, implanted medical devices, and other wearable sensors. The contact lens 905 captures motion sensor data and computes lens pose (i.e. orientation with respect to an earth-fixed reference frame) based on the data. Eye angle is an example of lens pose. The off-the-shelf, wearable device 950 may have an internet connection. The device 950 may run applications which output two-dimensional graphics that are loaded onto the canvas.

In a first example, the off-the-shelf, wearable device 950 runs applications and transmits vector graphics to the contact lens. The lens 905 computes its pose, renders the graphics by performing two-dimensional (x, y) shifts, and displays the graphics on a projection display which projects images onto the wearer's retina. The lens 905 may send user-interface requests to the wearable device in order to interact with the application running on the wearable device. For example, a lens wearer may interact with an application by looking at displayed objects. Information about which object the wearer looked at, i.e. pose information, may be sent to an application running on the wearable device. An example of this scenario is a smart watch running a heart rate monitoring application. The watch sends vector graphics (or, alternatively, character codes, e.g. ASCII) to the lens so that the lens can display heart rate information to the user. The lens requests the information from the wearable device whenever the user activates (e.g. by looking at) a user interface symbol shown on the contact lens display.

In a second example, an application runs on the contact lens CPU and GPU while the off-the-shelf, wearable device fetches data from the internet on request, and provides application updates as needed. An example of this scenario is a contact lens running a local weather application. The lens sends a request to a wearable or mobile device (e.g. smart watch or smart phone) which looks up the required information (e.g. temperature, cloud cover) on the internet and sends it to the application running on the contact lens for display.

In these independent electronic contact lens systems, the lens computes its own pose. It does not rely on a custom accessory to perform pose or real-time graphics rendering computations. Applications may run on the contact lens or on an off-the-shelf device such as a smart watch or wearable sensor. A wearable device may fetch data from the internet as an input to the application. Graphics displayed on the lens are two-dimensional. There is no need to compute a perspective view of a 3D scene every time the lens pose changes. When an application runs on an off-the-shelf device, the lens may be thought of as running an interpreter which displays vector (or simpler) graphics generated by the device.

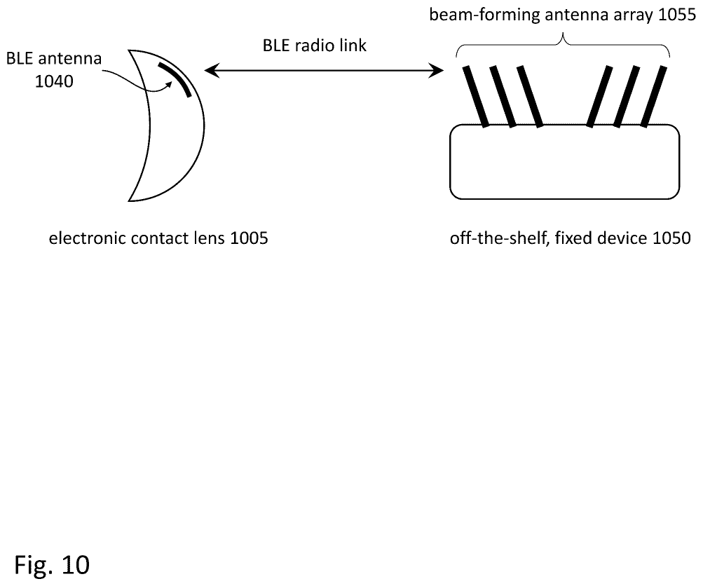

The system of FIG. 10 is similar to that of FIG. 9, except the off-the-shelf device 1050 which communicates with the electronic contact lens 1005 is a fixed device. The fixed device may have an internet connection. It may run applications and send 2D vector graphics to a contact lens in response to user interface requests. The fixed device may include a beam-forming (or electronically scanned) antenna array 1055. The array includes several independent antennas, the relative phase of which may be electronically adjusted. In this way the antenna array may be aimed at, and track the movements of, a contact lens wearer. Compared to the wearable device of FIG. 9, the fixed device of FIG. 10 may use more power and perform more complex computations. Such devices may be distributed throughout a building or be located in a vehicle. The devices may have a continuous, direct view of a lens wearer's eyes, in which case the performance requirements for the contact lens radio transceiver may be relaxed as the fixed device may have more effective transmit power and better receive sensitivity than a wearable device.

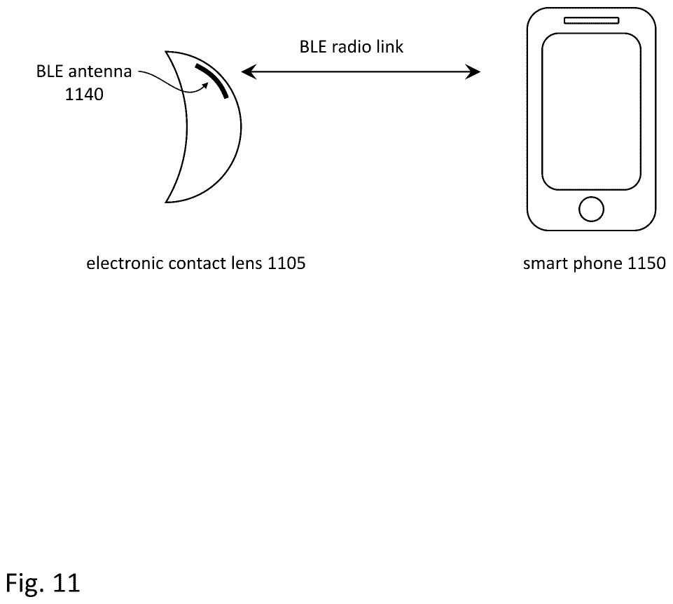

The system of FIG. 11 is similar to that of FIG. 9 except the off-the-shelf device 1150 is a smart phone. The smart phone fetches data from the internet and processes lens application updates (e.g. if the lens needs to load a new application into its memory). The lens 1105 communicates with smart phone via a standard UHF link such as BLE. One difference between the wearable example of FIG. 9 and the smart phone example of FIG. 11 is that the position of a smart phone compared to a person using it is less predictable. A smart watch is almost always mounted on a person's wrist, but a smart phone could be set down temporarily, for example. A smart phone can store many more applications and fetch more complex data from the internet, however. The smart phone, may collect internet data and perform some processing steps on the data before sending it to the lens.

In an independent system, a contact lens may compute its own pose and render 2D graphics in response to changes in pose. This is possible because rather than having to compute a perspective view of a 3D scene, rendering may be as simple as performing a lateral shift.

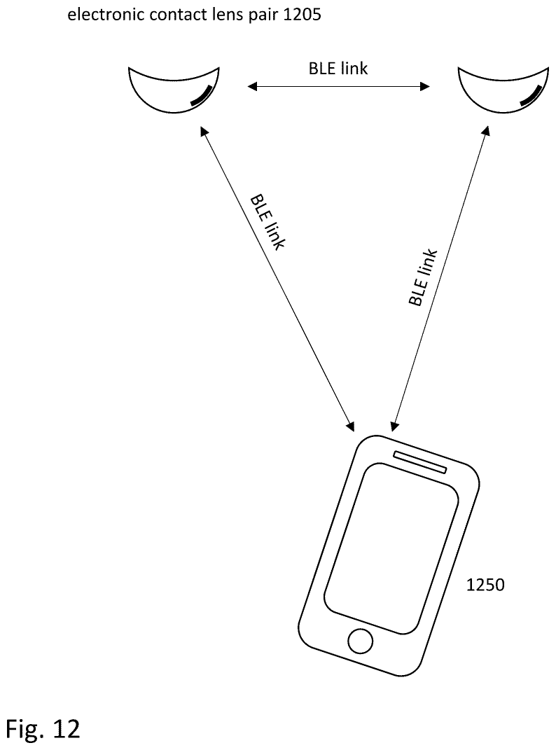

Pairs of electronic contact lenses may be worn on both eyes and coordination between the lenses may be helpful depending upon a particular application. FIG. 12 shows a pair 1205 of electronic contact lenses in an independent system. Each lens in a pair may run the same app independently. Lenses coordinate operation among themselves via a lens-to-lens UHF radio link. For example, one eye can be the master and the other the slave for user interface purposes. The user's dominant eye may be selected as the master. When the master eye selects a user interface object (e.g. by looking at it), the app running in the other eye acts as if it had selected the same object.

Two lenses may communicate with one another and/or with an off-the-shelf device 1250 such as a smart watch or smart phone. The off-the-shelf device may provide a time reference signal for the lenses, or it may provide a time reference for only one lens. In the latter case, the other lens may sync itself to the lens which has synced with the off-the-shelf device.

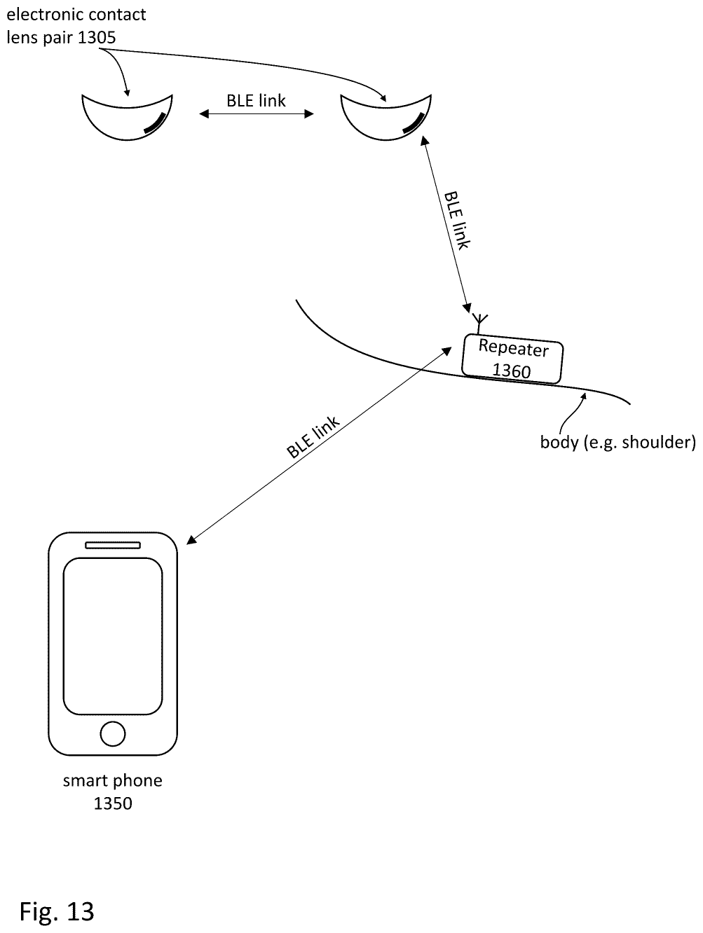

FIG. 13 illustrates an independent electronic contact lens system with a body-worn repeater. In FIG. 13 a pair 1305 of electronic contact lenses communicates with each other via UHF radio link, e.g. a Bluetooth Low Energy link. The lenses also communicate with a smart phone 1350. However, the smart phone cannot be assumed to remain in a well-defined position with respect to the lenses. Signal losses across the smart phone to lens communication link may become intolerable if the phone is put down and the lens wearer turns away from it. Hence, in the system of FIG. 13, the user also wears a small radio repeater 1360. The repeater is located in a position on the body from which an acceptable link budget may be maintained with the lenses. For example, the repeater may be located on a person's shoulder, chest or hat. These locations, slightly away from the body surface, not sunk into eye sockets offer much better propagation to external devices such as smart phones. The repeater may be a “dumb” repeater in that it need not perform any data manipulation. It just improves signal strength. On the other hand, a smart watch or other wearable device may also be provisioned to act as a repeater.

Although the detailed description contains many specifics, these should not be construed as limiting the scope of the invention but merely as illustrating different examples. It should be appreciated that the scope of the disclosure includes other embodiments not discussed in detail above. For example, the independent graphics pipeline described herein may be used with other devices, including in intraocular lenses and other types of eye-mounted devices. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. An eye-mounted device comprising:
a display that projects pixels onto a retina of a user's eye;
a memory storing an application, and a processing device coupled to the memory to execute the application, wherein executing the application causes the processing device to populate a canvas with images of rendered graphic objects used by the application; and
a real-time graphics module configured to, repeatedly and in real-time, transfer the images of the rendered graphic objects from the canvas to the display;
wherein the display, memory, processing device and real-time graphics module are contained within the eye-mounted device.

2. The eye-mounted device of claim 1, wherein the real-time graphics module is further configured to receive an eye angle of the user's eye; determine, based on the eye angle, which graphic objects fall within a display window of the display; and transfer the images for those graphic objects from the canvas to the display.

3. The eye-mounted device of claim 2, further comprising:
one or more accelerometers, a gyroscope and a magnetometer; and
an eye tracking unit that determines the eye angle based on measurements from the one or more accelerometers, the gyroscope and the magnetometer.

4. The eye-mounted device of claim 2, wherein the real-time graphics module refreshes the display at a frame rate of at least 100 frames per second.

5. The eye-mounted device of claim 1, wherein executing the application also causes the processing device to generate a listing of the graphic objects in the canvas, and sizes and locations of the graphic objects.

6. The eye-mounted device of claim 5, wherein, for at least one of the graphic objects, the listing includes multiple locations for the graphic object.

7. The eye-mounted device of claim 5, wherein the real-time graphics module is further configured to receive an eye angle of the user's eye; determine, based on the eye angle and on the sizes and locations of the graphic objects in the listing, which graphic objects fall within a display window of the display; and transfer the images for those graphic objects from the canvas to the display.

8. The eye-mounted device of claim 1, further comprising:
a graphics engine that renders graphics objects into pixels.

9. The eye-mounted device of claim 8, wherein the graphics engine renders text into pixels.

10. The eye-mounted device of claim 1, wherein the processing device populates the canvas by transferring images of pre-rendered graphic objects to the canvas.

11. The eye-mounted device of claim 1, wherein, for at least one graphic object, the processing device populates the canvas with images of at least two different versions of the graphic object.

12. The eye-mounted device of claim 1, wherein the graphic objects are two-dimensional flat objects at a fixed distance and of a fixed size.

13. The eye-mounted device of claim 1, wherein the processing device populates the canvas with images of all graphic objects used by the application prior to the transfer of images by the real-time graphics module.

14. The eye-mounted device of claim 1, wherein the canvas is updated with images of new graphic objects during the operation of the real-time graphics module.

15. The eye-mounted device of claim 14, wherein the operation of the real-time graphics module has priority over the updating of the canvas.

16. The eye-mounted device of claim 1, wherein, the real-time graphics module refreshes the display at a frame rate of the display by transferring from the canvas the images for all graphic objects that fall within a display window of the display.

17. The eye-mounted device of claim 1, wherein the display comprises a display buffer that stores images transferred from the canvas to the display, and the display projects the images stored in the display buffer.

18. The eye-mounted device of claim 17, wherein the real-time graphics module shifts images in the display buffer based on changes in an eye angle of the user's eye.

19. The eye-mounted device of claim 17, wherein the real-time graphics module does not refresh the display buffer if an eye angle of the user's eye does not change.

20. The eye-mounted device of claim 1, further comprising:
a wireless link to outside the eye-mounted device.

21. The eye-mounted device of claim 20, wherein operation of the real-time graphics module does not use the wireless link.

22. The eye-mounted device of claim 20, wherein the wireless link is used to upload the application onto the eye-mounted device.

23. The eye-mounted device of claim 20, wherein the wireless link is a Bluetooth low energy (BLE) link.

24. The eye-mounted device of claim 1, further comprising:
a contact lens that contains the display, the memory, the processing device and the real-time graphics module.
